(19) United States
(12) Patent Application Publication
(10) Pub. No.: US 2018/0121521 A1
(43) Pub. Date: May 3, 2018

(54) TIME-BASED REPORTING OF DATA USING A DATABASE SYSTEM

(71) Applicant: salesforce.com, inc., San Francisco, CA (US)

(72) Inventor: Oleg Bivol, San Ramon, CA (US)

(21) Appl. No.: 15/337,874

(22) Filed: Oct. 28, 2016

(51) Int. Cl. G06F 17/30; G06Q 30/02

(52) U.S. Cl. CPC G06F 17/30551; G06Q 30/0242; G06F 17/30554

(57) ABSTRACT

Disclosed are examples of systems, apparatus, methods and computer program products for providing time-based reporting of data by manipulating non-relational data sets. A first set of records in a non-relational database are identified, containing first marketing campaign data for one or more dates. A second set of records is then generated based on the first set of records. The second set of records is generated by deriving second marketing campaign data for a designated date range from the one or more dates in the first set of records, then populating the records with the second marketing campaign data for the designated date range. The second set of records is then stored in a relational database. A query is received including at least one record from the second set of records, and a query result is generated in real time or substantially real time.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to data manipulation and storage, and more specifically to providing time-based reporting of data by manipulating non-relational data sets.

### BACKGROUND

“Cloud computing” services provide shared resources, applications, and information to computers and other devices upon request. In cloud computing environments, services can be provided by one or more servers accessible over the Internet rather than installing software locally on in-house computer systems. As such, users having a variety of roles can interact with cloud computing services.

### BRIEF DESCRIPTION OF THE DRAWINGS

The included drawings are for illustrative purposes and serve only to provide examples of possible structures and operations for the disclosed inventive systems, apparatus, methods and computer program products for providing time-based reporting of data by manipulating non-relational data sets. These drawings in no way limit any changes in form and detail that may be made by one skilled in the art without departing from the spirit and scope of the disclosed implementations.

FIG. 1 shows a system diagram of an example of a system 100 for providing time-based reporting of data by manipulating non-relational data sets, in accordance with some implementations.

FIG. 2 shows a flowchart of an example of a method 200 for providing time-based reporting of data by manipulating non-relational data sets, performed in accordance with some implementations.

FIG. 3 is an example screenshot 300 of a marketing campaign's report of campaign activity, prior to the use of the methods described in this application.

FIG. 4A shows an example of an engagement history table 400 containing a first set of campaign marketing data stored in a first set of records, in accordance with some implementations.

FIG. 4B shows an example of an engagement history aggregate table 440, or aggregate table, in accordance with some implementations.

FIG. 5A shows an example of an engagement history summarized table 500, or summary table, in accordance with some implementations

FIG. 5B shows an example of an engagement history summarized table 540 with additional delta of a dataset, in accordance with some implementations.

FIG. 6A shows an example of a graphic 600 generated based on summarized data, in accordance with some implementations.

FIG. 6B shows a second example of a graph 650 based on summarized data, in accordance with some implementations.

FIG. 7A shows a block diagram of an example of an environment 10 in which an on-demand database service can be used in accordance with some implementations.

FIG. 7B shows a block diagram of an example of some implementations of elements of FIG. 7A and various possible interconnections between these elements.

FIG. 8A shows a system diagram of an example of architectural components of an on-demand database service environment 900, in accordance with some implementations.

FIG. 8B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for providing time-based reporting of data by manipulating non-relational data sets.

In some database systems, one or more organizations or enterprises may capture and process data relating to marketing campaigns. These marketing campaigns can generate data captured from various events, such as marketing emails sent to groups or individuals, login or interaction data on websites, forms or fields used to collect data on the internet, and more. In many instances, the generating and capturing of data, as well as the storage, may be an automated process. The data may be stored in one or more databases in the database system. Traditionally, marketing and campaign data was stored within a relational database, such as Oracle. This allowed the data to be stored in a table with rows and columns that may be indexed, sorted, and queried in multiple, flexible ways, leading to easy and flexible generation of reports, graphs, and visuals for the data that could give a sense of how campaigns work over time.

While this may have worked for some organizations in earlier years, campaigns increasingly generate an enormous amount of data. Everything related to a marketing campaign can potentially be captured, and this information is highly desirable to organizations that wish to monitor the efforts and effectiveness of the campaigns. For example, an organization may wish to track every page view of a site, every email delivered, whether a recipient opened a specific email or clicked on a specific link in the email, and much more. Relational databases typically are not optimized for storing very large amounts of unstructured data, such as the large amounts of automatically captured data in a marketing campaign.

For this reason, non-relational database systems have become very popular in recent years. Non-relational database systems are ideal for applications that need access to large amounts of data. They provide flexible, scalable database schemas for large datasets. One such non-relational database is HBase. Non-relational databases can lead to fast, real-time capturing of large amounts of unstructured data. While this is useful and necessary for modern marketing data, non-relational databases are typically not optimized for fast, low-cost, flexible querying and retrieval of this unstructured data. There may be one or two ways of quickly querying data based on indexing, but this is often not enough. For example, campaign email data may include the email, the recipient, and links. This data may be optimized in a non-relational database for retrieving all emails sent for a particular recipient, but it may not be optimized for retrieving all links in an email, or all emails ever sent to the user. Non-relational databases have a narrow access path, and require thinking ahead about which indexes are important to use, because they will have a large impact. It is often impossible to generate flexible, useful graphics, graphs, and reports based on the data in granular ways, especially in terms of summarizing campaign data over periods of time.

By way of illustration, Acme is a company that is interested in tracking and understanding data from its marketing campaign, which happened during a high-profile rollout of a new video game console. Several phases of the campaign proceeded over time, the most important being a digital advertising and media blitz during the Christmas holiday season. Acme uses a customer relationship management service to manage all of the campaign data, which can be captured automatically and stored within a non-relational database that the service maintains. While this provides for very convenient, fast, and efficient storage of enormous amounts of data generated every minute for the campaign, with its various emails, online ads, targeted links, and more, Acme finds that the service limits tracking of specific uses of that data, such as tracking over time the amount of targeted emails received by users in a certain demographic in the past three quarters. The service informs Acme that the non-relational database technology used for capturing trillions of pieces of data limits searching and querying that data to only one or two indexes. Other searches are not optimized, and would be very expensive, slow, and inefficient. Generally, querying the relational, large set of data would be done asynchronously, leading to results sometimes taking hours to be generated. Acme is thus unable to have near-instant, flexible access to a variety of reports on its campaign data.

Some of the disclosed techniques can be implemented to provide for generating time-based reporting of data, by summarizing and aggregating sets of non-relational data into smaller sets of relational data that can be queried with more efficiency and flexibility. First, raw data is entered into an engagement history table in a non-relational database. At specific time intervals, the raw data is summarized and manipulated into a new table with a designated number of rows for engagement times. In some implementations, these specific time intervals may be daily, weekly, monthly, quarterly, or yearly snapshots. The data from the new summarized table is then pushed to a relational database, where the fixed, small number of rows allows for predictable storage of the data. A query can then be generated relating to the data from the new summarized data in the relational database, and results for the query can be returned in real-time or substantially real-time, due to the predictive, relational nature of the data. In some implementations, a graphic can then be generated for the data with little processing overhead.

Applying some implementations of the disclosed techniques, an alternative scenario to that described above is provided. In this alternative scenario, the customer relationship management service that Acme uses has announced a new update. This update allows large amounts of marketing campaign data to be captured and pushed into a non-relational database. The service periodically summarizes the data for Acme. The theory the service uses is that as marketing data ages, granularity becomes less important. If a marketing campaign is run last week, a company would be interested in how it performed each day of the week. But the company likely would not place the same importance on how a specific campaign performed on a single day one year ago; rather, it would be interested in overall performance in Quarter 1, for example. Accordingly, the service summarizes data in less granular ways as time goes on. For example, day 1 through day 7 are captured in table rows depicting daily snapshots of the data; week 1 through week 4 are captured in weekly snapshots; month 1 through month 12 are captured in quarterly snapshots; and each year is captured in a yearly snapshot. These summaries contain aggregate totals of records made for campaign data within those given periods. For example, if 1,000 records of an email being received are captured from April through June, then a single record might be created as a summary of the data, saying that 1,000 records have been made in Quarter 1. These summarized pieces of data appear in a predictable number of rows with a combination of daily, weekly, quarterly, and yearly aggregates. This summarized table is pushed to a relational database, where the summarized data can be searched and queried in various ways, and results can be returned very quickly, in real time or substantially real time. Rather than waiting hours for results to arrive asynchronously, the results may appear within a matter of seconds. Time series reports are also dynamically generated for the customer at regular intervals based on this summarized data. Thus, Acme is able to capture and store large amounts of unstructured marketing campaign data, while still obtaining accurate, structured reports on how campaigns have performed over time, according to various metrics, throughout the lifetime of the campaign.

In some but not all implementations, the disclosed methods, apparatus, systems, and computer-readable storage media may be configured or designed for use in a multi-tenant database environment or system.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

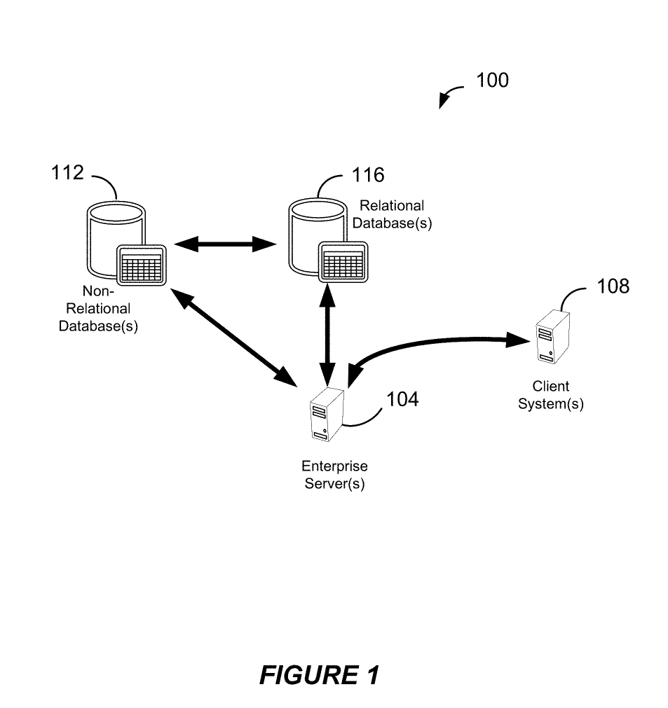

FIG. 1 shows a system diagram of an example of a system 100 for providing time-based reporting of data by manipulating non-relational data sets, in accordance with some implementations. System 100 includes a variety of different hardware and/or software components which are in communication with each other. In the non-limiting example of FIG. 1, system 100 includes at least one enterprise server 104, at least one client system 108, at least one non-relational database 112, and at least one relational database 116.

Non-relational database 112 can allow for storage and retrieval of large sets of data. The non-relational database 112 can be a database implemented in HBase or other non-relational database management system. This database can include one or more records for each of a plurality of enterprises (also referred to as organizations, or tenants.) In some implementations, the database can include one or more tables in which one or more enterprises have records. In some implementations, methods and applications are provided for the storage of data being captured in real-time. For example, the non-relational database 112 may log and capture event data for a campaign, where every time an email is received by its recipient, a new record is stored in a table for email campaign data.

Relational database 116 can allow for storage and retrieval of sets of data. In some implementations, the relational database 116 can store and maintain records and data objects relating to a campaign, such as user information, emails sent, campaign summary data, and more. In some implementations, relational database 116 can be searched and queried in various ways by a user or maintainer of system 100, providing for reports, graphs, data summaries, and other pieces of information relating to a campaign.

Enterprise server 104 may communicate with other components of system 100. This communication may be facilitated through a combination of networks and interfaces. Enterprise server 104 may handle and process data requests from the client system 108. Likewise, enterprise server 104 may return a response to client system 108 after a data request has been processed. For example, enterprise server 104 may retrieve data from one or more databases, such as the non-relational database 112 or the relational database 116. It may combine some or all of the data from different databases, and send the processed data to client system 108.

Client system 108 may be a computing device capable of communicating via one or more data networks with a server. Examples of client system 108 include a desktop computer or portable electronic device such as a smartphone, a tablet, a laptop, a wearable device such as Google Glass®, another optical head-mounted display (OHMD) device, a smart watch, etc. Client system 108 includes at least one browser in which applications may be deployed.

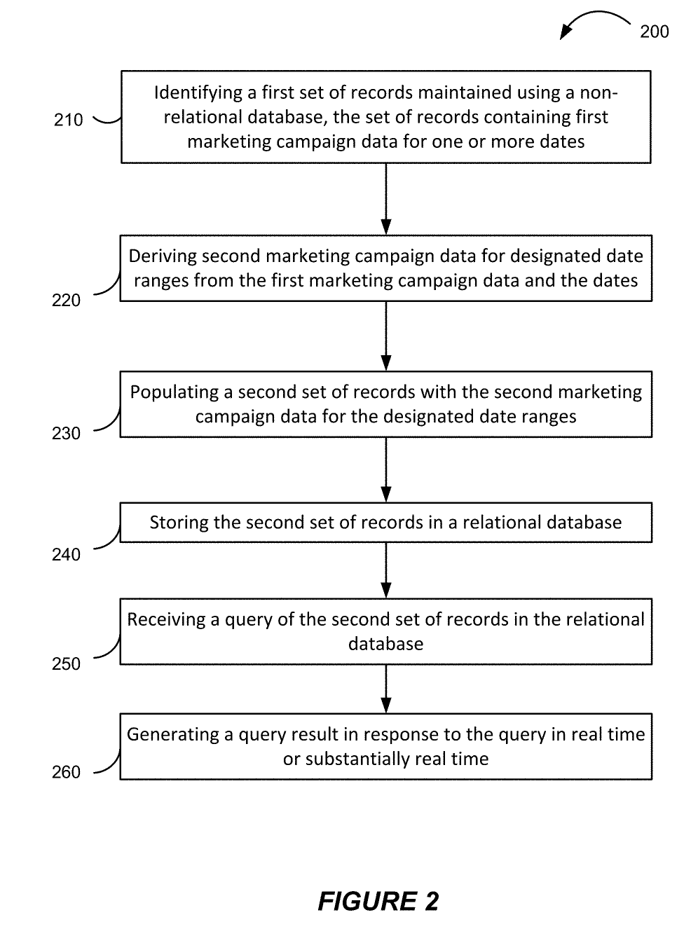

FIG. 2 shows a flowchart of an example of a method 200 for providing time-based reporting of data by manipulating non-relational data sets, performed in accordance with some implementations. Method 200 and other methods described herein may be implemented using system 100 of FIG. 1, although the implementations of such methods are not limited to system 100.

At block 210, the system identifies a first set of records maintained using a non-relational database 112. The set of records contains a first set of marketing campaign data tied to one or more dates. In some implementations, the first set of marketing campaign data takes the form of a plurality of records in the non-relational database 112. In some implementations, the records are stored in a table. The table may be labeled, for example, an engagement history table. In some implementations, the records may have fields related to the marketing campaign. For example, for a marketing campaign in which emails are sent to prospective customers, there may be records related to the emails that are sent. A record may, for example, including fields for the campaign ID, who sent the email, the recipient name of the email, the action that was registered, and the date and time the action was registered. In some implementations, each record is tied to at least one enterprise or organization. This may take the form, for instance, of a tenant ID that is unique to each organization. The record may then include a field for tenant IDs. In some implementations, the marketing campaign data is tied to one or more dates via one or more fields that include information on a date. For example, a record related to a sent email may have a “Date” column with data for that column entered as “May 1, 2016.”

At block 220, the system derives a second set of marketing campaign data, for designated date ranges, from the first set of marketing campaign data and the one or more dates. In some implementations, the second set of marketing campaign data takes the form of data for records. In some implementations, one or more records in the non-relational database 112 may contain the derived second set of marketing campaign data. In some implementations, the second set of marketing campaign data may be derived from fitting one or more of the dates in the first set of marketing campaign data into one or more designated date ranges. In some implementations, the designated date ranges may be selected from one or more data ranges. In some implementations, the designated date range to fit dates into may be determined based on one or more formulas or algorithms for determining a date range. In some implementations, designated date ranges may include one or more of an hourly, daily, weekly, monthly, quarterly, and yearly date range (also referred to as “snapshots”.) An example of an algorithm for determining a designated date range may include, for example, using an hourly date range when a campaign is in its first day; using a daily date range when a campaign is in its first 6 days; using a weekly date range when 24 days have passed; using a monthly date range when 330 days have passed; and using yearly date range when 3,650 days have passed. Other configurations can be used depending on the preferences of the maintainer of the system, an enterprise whose data is being summarized, or other users of the system. Designating such date ranges may be referred to as “time decay”, and are possible due to the predictive nature of the data. Rather than having a large, un-fixed number of records, a second set of data has one or more fields removed compared to the first set of data. In this way, the second set of records is a set, fixed number of records. This set number of records can be used to present a fixed set of designated date ranges according to an algorithm. Since the number of records is fixed, data can be presented over time in organized, set ways.

In some implementations, deriving the second set of marketing campaign data is done, at least in part, by aggregating one or more subsets of records from the first set of records, where the subsets of records each correspond to a date included in the designated date range. For example, an enterprise may have 1,000 records relating to email data. 300 of these records may have been sent on May 1, 2016, and 700 may have been sent on May 2, 2016. Twelve days into the campaign, the maintainers of the system may wish to start summarizing the records of dates into one or more weekly aggregate records. The system may be configured to automatically aggregate all records from May 1, 2016, to May 7, 2016. A new record is added to a summary table with columns similar to the engagement history table. The system may call it an engagement history summary table, or engagement history summarized table. The table may have a column in addition to or replacing one or more columns, named, for example, a “Count” or “Aggregate” column. This column may add up all similar records for any given date that falls with the designated date range. The “Count” field for the record in the above example may contain the data “1,000”, designating all of the emails sent on May 1 and May 2, both of which fall between the designated date range of May 1 through May 7.

In some implementations, before the deriving the second campaign marketing data takes place, the system aggregates one or more subsets of records from the first set of records into one or more aggregate records, the subsets of records each corresponding to a single date from the one or more dates. In some implementations, the aggregating may occur by adding up the total records that fall within a single date from the one or more dates tied to the first set of records. For example, if 300 records are tied to the date of May 1, 2016, then an aggregate record may be created in a table, with a Count field containing the data “300”, designating the summarized count of all records related to May 1, 2016. The table may be called, for example, an engagement history aggregate table, or simply an aggregate table. In some implementations, following this initial aggregating, the system may derive the second set of campaign marketing data by adding up all the aggregate records that fall within a designated date range. For example, if one aggregate record shows a count of 300 records for May 1, and another aggregate record shows a count of 700 records for May 2, then a designate date range of May 1 through May 7 may derive second campaign marketing data with a Count record of 1,000 for that designate date range.

At block 230, the system populates a second set of records with the second set of marketing campaign data for the designated date ranges. The system may populate one or more records relating to summary data for designated date ranges. In some implementations, each piece of campaign marketing data derived from a single record from the first set of records gets placed in a record in a second set of records. In the above example, if campaign data was derived showing a count of 1,000 for the designated date range off May 1-May 7, then that data can be populated in a single record with a count of 1,000, a FromDate field of May 1, and a ToDate field of May 7, corresponding to the designate date range. In this way, individual records capturing data events are summarized into record counts of designated date ranges at block 220, and then those summaries become records to be added to an engagement history summary table at block 230.

At block 240, the system stores the second set of records in a relational database. In some implementations, the relational database may be an Oracle database or other database that uses a Structured Query Language (SQL). In some implementations, the non-relational data may go through one or more steps to be converted or otherwise entered as relational, structured data. In some implementations, an application, such as Phoenix, or one or more drivers may perform these steps to convert the data into relational data capable of being read by the relational database. In some implementations, the non-relational data from the second set of campaign marketing data may be entered into one or more virtual tables before populating the relational database.

In some implementations, the new second set of records, which provide aggregate summaries along designated date ranges, may be presented to an enterprise associated with that data. For example, if the records show a tenant id field related to an enterprise, that enterprise may be interested in the summarized data. In some implementations, updated data from the table is automatically presented to the enterprise at regular intervals.

In some implementations, the system generates one or more additional records, each including a date outside of the designated date ranges, and then the system aggregates additional records based on a second designated date range. This may occur when data has already been summarized using the methods in blocks 210-240, and then later new, additional records have been added to the first set of records. This may occur because when an organization is capturing data in real-time, there may always be new records added to the non-relational database at any given time. Thus, even after summarizing and pushing data into a relational table, more data may come in from dates outside of those designated date ranges. In such a situation, in some implementations, the system may identify the delta of the dataset, meaning the records in the first set of records that have not been summarized. The system then determines whether these records would fit in any current summarizing record. In some implementations, it runs through the designated date ranges listed for each record in the summary table, and determines whether there is a match for the date tied to any of the records. If so, those records get aggregated into the summary records, and the Count field of the summary records increases accordingly. In some implementations, if the records don't fall within any of the date ranges, then the system may evaluate them for inclusion at regular intervals, or when new summary records get added to the summary table. For example, 50 new records may be added to an engagement history table on June 4. The system determines that the date tied to the records does not fall within the designated date ranges in the summary table. At a later point, a new record in the summary table gets added, with a designated date range of June 2 to June 9. The system checks if any records in the engagement history table should be aggregated to this summary record. Since the 50 new records qualify, the system aggregates those records into the record in the summary table. In this way, in addition to the first summary and manipulations of blocks 210-240, there are additional summarizing steps for additional new data that gets captured in the non-relational database. In some implementations, this can be an ongoing process at periodic intervals.

At block 250, the system receives a query of the second set of records in the relational database. The query can be received from any entity accessing the database and using it to retrieve data. For example, the organization responsible for the marketing campaign may wish to query data to see how the campaign has performed over time. In some implementations, the query may be in SQL format. The query is targeted specifically at one or more records in the second set of records. The query is thus directed at the newer, summarized data, and not the older, large data set in the non-relational database.

At block 260, the system generates a query result in response to the query in real time or substantially real time. The smaller, fixed number of records in the second set of records allows for real time or substantially real time queries against a modified, summarized version of the data. Queries against the original data, with a large, non-set number of records, would only be asynchronous queries, not real time queries. With asynchronous queries, results may only be received after some time, such as hours later. With real time or substantially real time queries, however, results can be received in some short, reliable, weighted amount of time, such as within ten seconds. The system is capable of generating a query result in real or substantially real time due to the relational nature of the second set of records. Since one or more fields have been removed in order to summarize the first set of records into the second set of records, and only a fixed number of records remains, generating a query result in real or substantially real time is now feasible.

In some implementations, the system additionally generates a graphic based on the second set of records, with graphical content corresponding to the second set of marketing campaign data and the designated date ranges. In some implementations, the graphic may be a time series graph. In some implementations, the graphic may be any other graph, chart, or other visual with time, date, or a date range as one of the inputs to the graphic. In some implementations, the graphic is generated by using the second set of marketing data as captured in the records that have populated the summary table in block 240. In some implementations, the designated date ranges of the records in the summary table are used to show how the data has shifted over time. For example, the system may generate a graphic showing how emails sent in a marketing campaign have increased or decreased throughout a year. The graphic uses records from the summary table that have used months as the designated date ranges, i.e., all days of January for one record, all days of February for another record, and so on. The graphic thus has points along an axis for January through December. The graphic also has numbers of emails sent for the other axis. It may show that 400 records were sent in January, 200 in February, 800 in March, and so forth. It may then show a line or curve to highlight these changes over time, at each month. Many other configurations of graphics generated from the summary records may be contemplated. In some implementations, one or more time series reports may be generated from the summary records in the same fashion, using any of a combination of graphics, textual data, charts, and other elements, visual or otherwise. In some implementations, the graphic is automatically, dynamically generated. In some implementations, the graphic may be automatically generated at regular designated intervals and presented to one or more users of the system. In some implementations, one or more users may customize elements of the graphic in various ways, or alter the data that is used to generate the graphic in various ways.

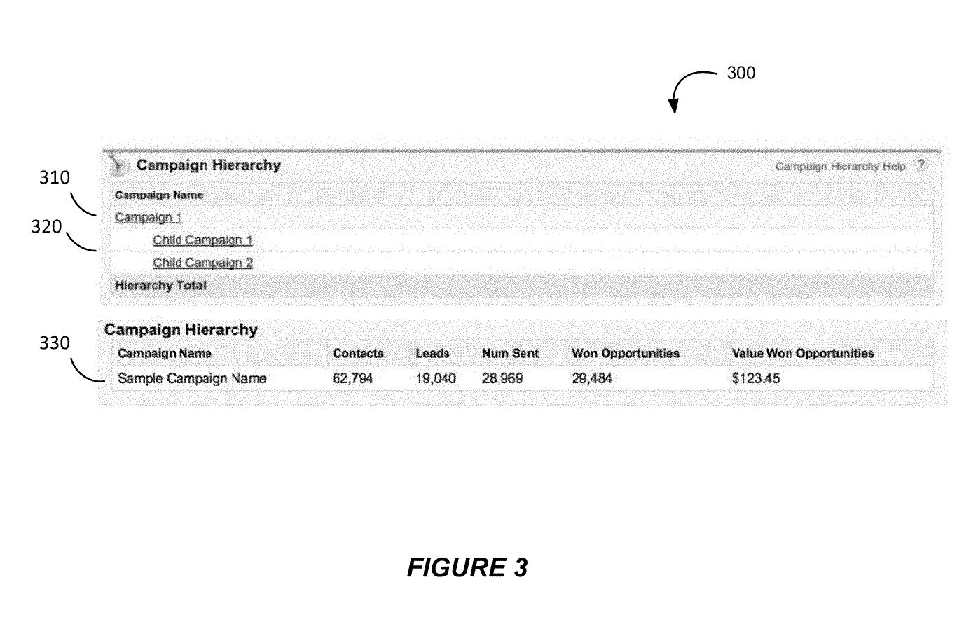

FIG. 3 is an example screenshot 300 of a marketing campaign's report of campaign activity, prior to the use of the methods described in this application. A parent campaign 310 is listed, which is the main campaign which is tied to data being recorded and stored in a non-relational database. The parent campaign 310 may have one or more child campaigns 320, which may represent segments or subsets of the parent campaign 310. A campaign summary 330 lists the total number of contacts, leads, number of emails sent, won opportunities, and the total value of won opportunities for the parent campaign 310 and any child campaigns 320. While this summary is useful for the enterprise running the organization, the limitations of the non-relational database capturing the information are such that a summary broken down by days, weeks, months, or years of the campaign may be very costly and prohibitive to provide to the enterprise. Since the data being captured is very large, with records in the trillions, the data is not easily sliced into many different designated time ranges for presenting to the user along many different metrics, in a desired flexible fashion. The methods described in this application provide a solution to this limitation.

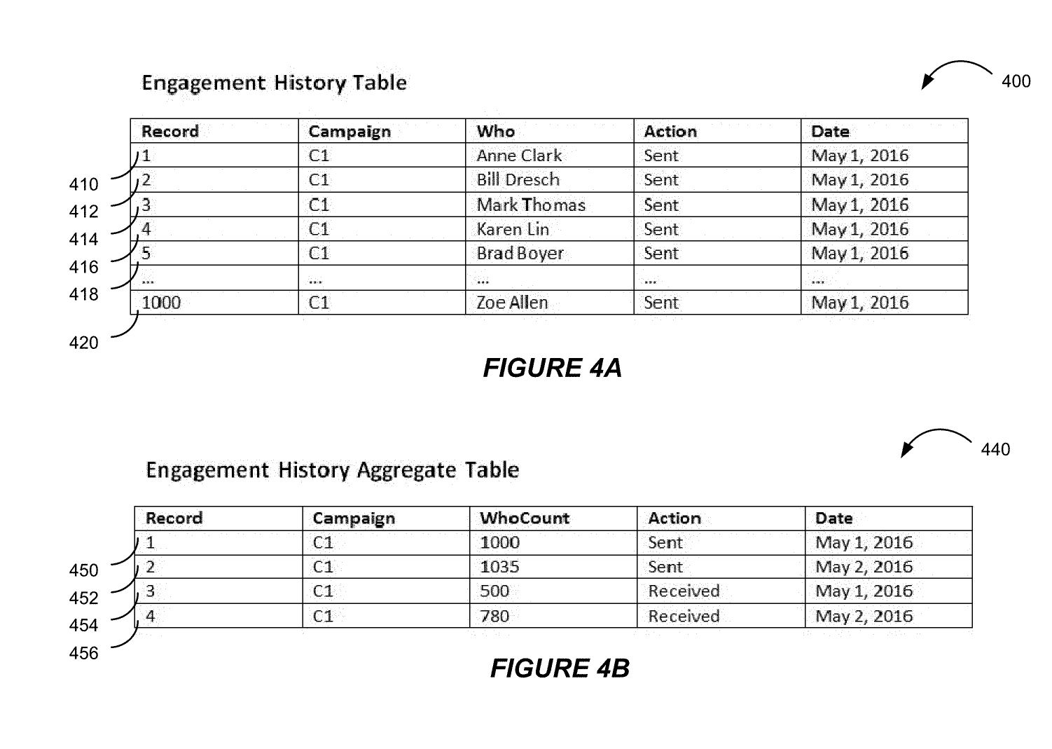

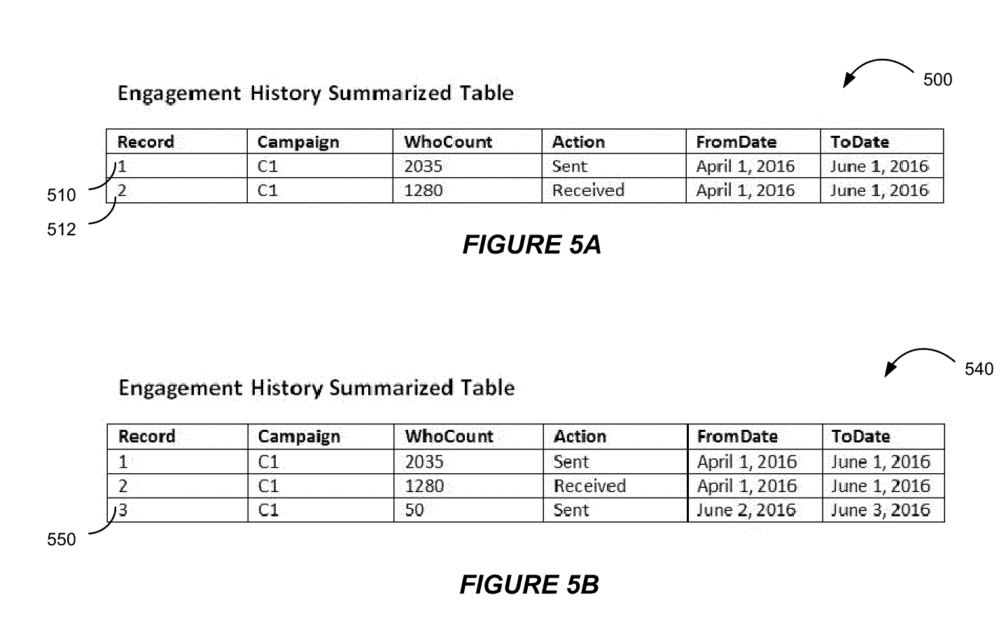

FIG. 4A, FIG. 4B, FIG. 5A, and FIG. 5B illustrate examples of non-relational marketing data being summarized, aggregated, and pushed into a relational database according to the methods described in this application.

FIG. 4A shows an example of an engagement history table 400 containing a first set of campaign marketing data stored in a first set of records, in accordance with some implementations. Records 410, 412, 414, 416, and 418 are the first four records in this engagement history table. Each record designates an event relating to a marketing email campaign conducted by an enterprise. Each record contains several fields relating to this marketing email campaign, including the Campaign ID, which is “C1”; a Who field, marking the name of the individual who the email was sent to; an Action field, designating which action was being recorded in the record; and a Date field, designating the date that the action occurred. Record 420 designates the 1,000^{th} record in this engagement history table. All records in this example have an action of “Sent”, meaning this was a record of an email being sent to a user. All records also have a date of May 1, 2016. In this example, this engagement history table is non-relational. The marketing data is being captured in real time by the enterprise and is being automatically stored in the table.

FIG. 4B shows an example of an engagement history aggregate table 440, or aggregate table, in accordance with some implementations. In some implementations, the engagement history aggregate table is a non-relational table populated with records by aggregating the records stored in engagement history table 400 according to each date out of the possible dates. In some implementations, the data aggregated may be from records stored in engagement history table 400, one or more other tables, or some combination thereof. Record 450 is the first record in the aggregate table, and is an aggregation of the records from the engagement history table 400 illustrated in FIG. 4A. The fields Record, Campaign, and Date are all identical to the fields of engagement history table 400, but there is a WhoCount field replacing the Who field. In the aggregate table, rather than listing individual usernames in individual records in a Who field, a count of an aggregated number of records corresponding to a given date is shown. In record 450, the 1,000 records of the engagement history table 400 are aggregated in the WhoCount field, with a Date of May 1, 2016, since all of the aggregated records share that date. Other records 452, 454, and 456 show different aggregated records from other tables or other portions of the engagement history table 400. Record 452 shows an aggregated number of records for emails that were sent the next day, May 2, 2016. Record 454 shows an aggregated number of records for emails that were received on May 1, 2016, rather than sent. Record 456 shows an aggregated number of records for emails that were received May 2, 2016. Each of these records are representing a different set of data that is being summarized.

The Who field being replaced by a WhoCount field in this figure is an example of reducing the amount of data offered in the summary table by removing one or more fields completely, also known as “field reduction.” The purpose of removing one or more fields is to present a known, set number of records in the summary table. With a set number of records, there is no uncertainty about how many total records there will be, and thus data can be neatly summarized and converted into a relational database format. FIG. 5A shows an example of an engagement history summarized table 500, or summary table, in accordance with some implementations. In some implementations, the summary table 500 is a non-relational table populated with records by aggregating the records stored in engagement history table 400 according to one or more designated date ranges. In some implementations, the summary table 500 is populated with records by aggregated the records stored in the aggregate table 440 according to one or more designated date ranges. The records in the summary table have the fields Campaign, for a campaign ID; WhoCount, for an aggregated number of records; Action, for the action the record is recording; FromDate, the beginning date of the designated date range; and ToDate, the ending date of the designated date range. Record 510 is the first record in the aggregate table 500. It includes a WhoCount of 2,035 for emails sent between the date range of April 1 to Jun. 1, 2016. In this example, record 510 is aggregated from the first two records 450 and 452 of aggregate table 440. Since record 450 had an aggregate of 1,000 records on May 1, and record 452 had an aggregate of 1,035 records on May 2, they both combine in the aggregated record 510 of the summary table, as both fall within the designated date range of April 1 to Jun. 1, 2016. Record 512 similarly aggregates the two records 454 and 456 for emails received on May 1 and May 2, respectively. In some implementations, new records may be added to the summary table at regular intervals, or according to a formula for summarizing data. In some implementations, any of an hourly, daily, monthly, quarterly, or yearly date range, or snapshot, may be designated periodically to summarize data.

FIG. 5B shows an example of an engagement history summarized table 540 with additional delta of a dataset, in accordance with some implementations. The first two records in the example are identical to record 510 and record 512 of FIG. 5A. The first two records illustrate the summarizing and aggregating of data from the first set of marketing campaign data. The third record 550 illustrates an additional record, or additional delta of the dataset, that an enterprise may wish to be further summarized. Record 550 shows a WhoCount field with 50 records, with emails sent between June 2 and June 3. Since the designated date range of record 550 does not fit in the designated date range of the first two records, which are April 1 to Jun. 1, 2016, Record 550 cannot be aggregated into the existing summary records of summary table 540. In some implementations, however, further records with other designated date ranges may be added to the summary table 540. In some implementations, summary records with different date ranges may be added periodically in order to summarize the data captured in the engagement history table 400. For example, the system may be configured to add daily date ranges up to a certain number of days, weekly date ranges up to a certain number of days, and so on. As these records are added periodically, the system determines whether any records in the summary table 540 or in other tables do not fit into the existing summary records of summary table 540. If any fit, they are aggregated within the appropriate record. If any do not fit, then they remain until further summary records are added that are appropriate.

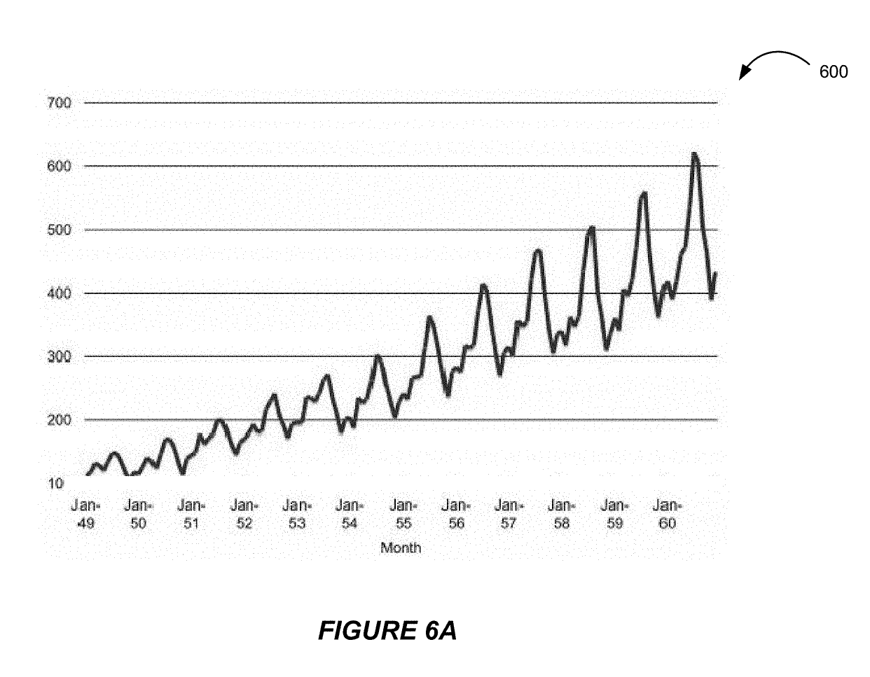

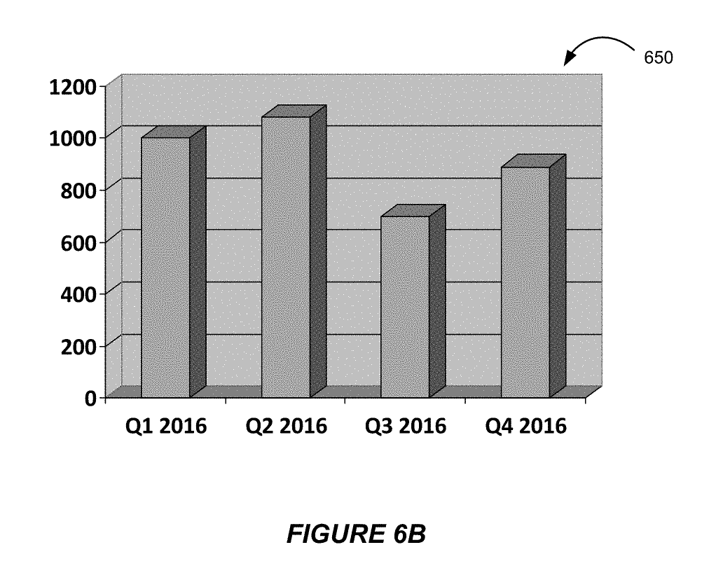

FIG. 6A shows an example of a graphic 600 generated based on summarized data, in accordance with some implementations. The graphic 600 is a time series graph that incorporates data from an engagement history summarized table, such as the summary table 500 in FIG. 5A. On the x axis of the graph are different points marking units of time, specifically months. The y axis of the graph shows numbers of records. The time series graph allows an enterprise or user to visualize the activity and effectiveness of a campaign over time. In some implementations, the time series graph is automatically generated for an enterprise or user. In some implementations, the graph may be generated at periodic intervals, or on request of an enterprise or user.

FIG. 6B shows a second example of a graph 650 based on summarized data, in accordance with some implementations. The graphic 650 is a bar graph that incorporates data from an engagement history summarized table, such as the summary table 500 in FIG. 5A. On the x axis of the graph are different points marking units of time, specifically quarters of the year 2016. The y axis of the graph shows numbers of records. At Quarter 1 of 2016, 1,000 records are shown. At Quarter 2, 1,030 records are shown. Similar data is shown for Quarter 3 and Quarter 4.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

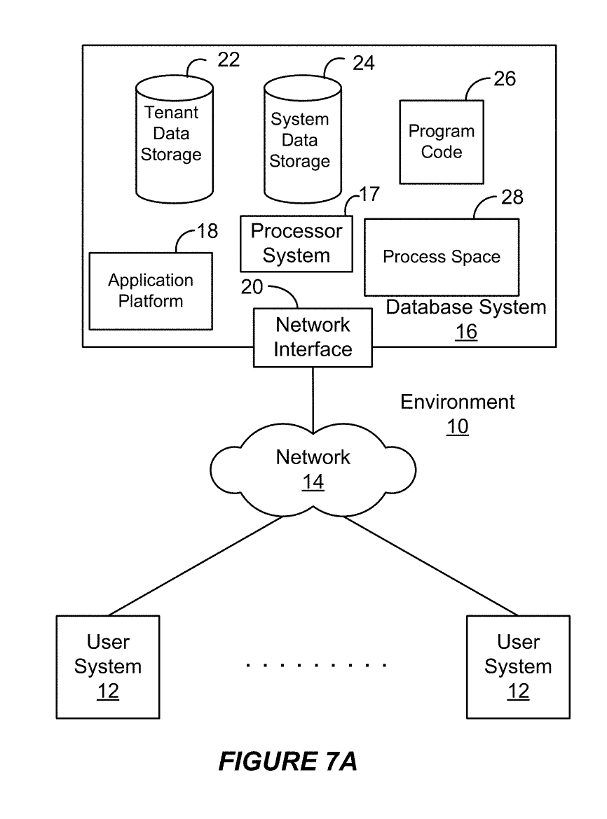

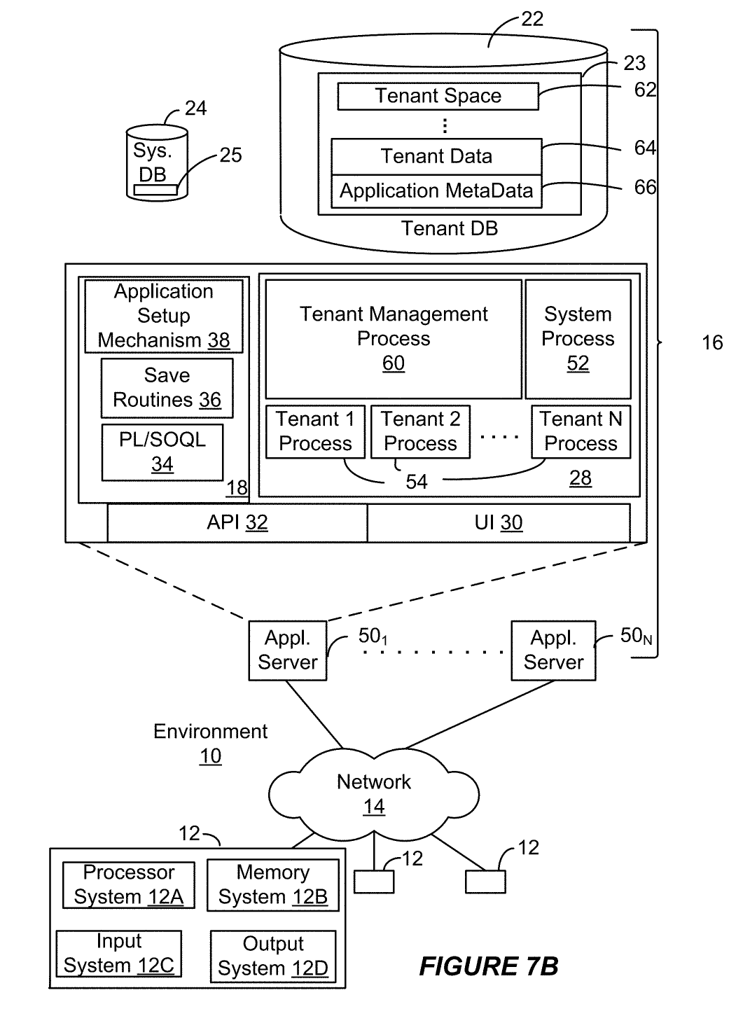

FIG. 7A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 7A (and in more detail in FIG. 7B) user systems 12 might interact via a network 14 with an on-demand database service, which is implemented in the example of FIG. 7A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). A non-relational database management system (NRDBMS) or the equivalent may execute storage and fast retrieval of large sets of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 7A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 7A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 7B shows a block diagram of an example of some implementations of elements of FIG. 7A and various possible interconnections between these elements. That is, FIG. 7B also illustrates environment 10. However, in FIG. 7B elements of system 16 and various interconnections in some implementations are further illustrated. FIG. 7B shows that user system 12 may include processor system 12A, memory system 12B, input system 12C, and output system 12D. FIG. 7B shows network 14 and system 16. FIG. 7B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 7A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 7B, system 16 may include a network interface 20 (of FIG. 7A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

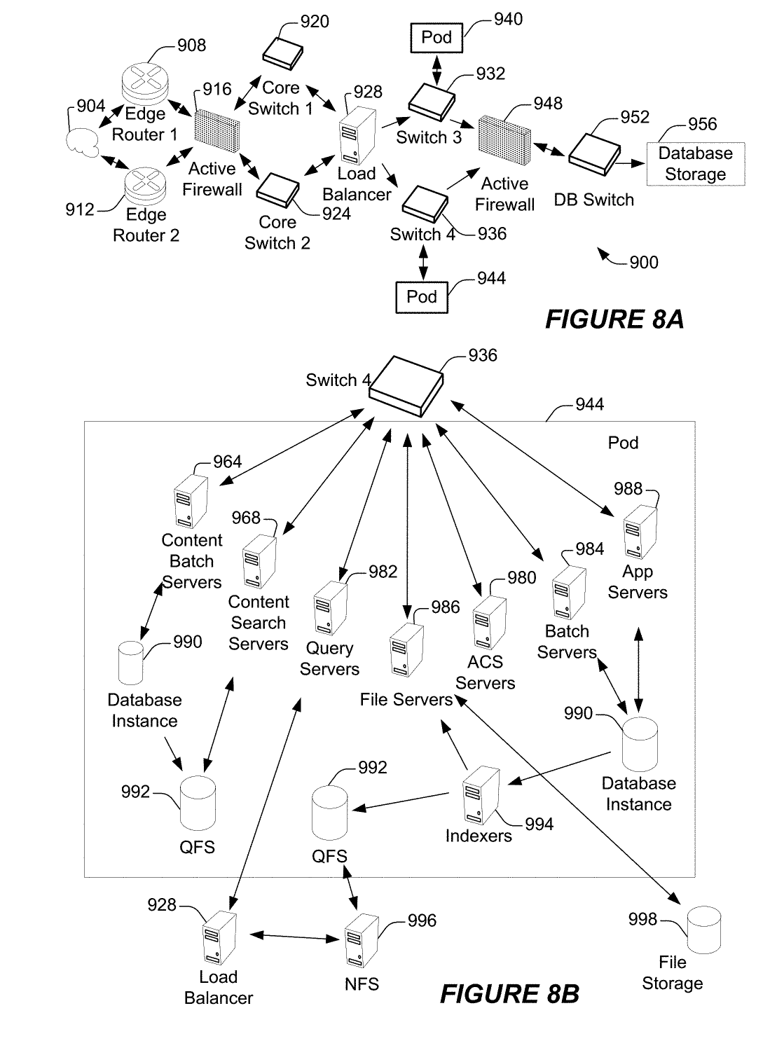

FIG. 8A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 8A and 8B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 8A and 8B, some implementations of an on-demand database service environment may include anywhere from one to many devices of each type. Also, the on-demand database service environment need not include each device shown in FIGS. 8A and 8B, or may include additional devices not shown in FIGS. 8A and 8B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 8B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 8A and 8B.

FIG. 8B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

Some but not all of the techniques described or referenced herein are implemented as part of or in conjunction with a social networking database system, also referred to herein as a social networking system or as a social network. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail herein.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described herein. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail herein, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned herein, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail herein. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system implemented using a server system, the database system configurable to cause:
identifying a first plurality of records maintained using a non-relational database, the first records comprising at least first marketing campaign data for one or more dates;
generating a second plurality of records based on the first records, the generating of each of the second plurality of records comprising:
deriving second marketing campaign data for a designated date range from at least a portion of the first marketing campaign data and from at least a portion of the one or more dates, and
populating a record with the second marketing campaign data for the designated date range;
storing the second records in a relational database;
receiving a query of the relational database, the query including at least one or more records from the second records; and
generating a query result in response to the query in real time or substantially real time.

2. The system of claim 1, further comprising:
generating a graphic based on the second records in the relational database to have graphical content corresponding to the second marketing campaign data and one or more designated date ranges of the second records, the graphic being displayable on a display of a device.

3. The system of claim 2, wherein the graphic comprises at least a portion of a time series report.

4. The system of claim 2, wherein the graphic is dynamically generated for a user of the database system at periodic intervals.

5. The system of claim 1, wherein the deriving second marketing campaign data for a designated date range comprises aggregating one or more subsets of records from the first records, the subsets of records each corresponding to a date included in the designated date range.

6. The system of claim 1, wherein the designated date range is one of: a day, a week, a month, a quarter, or a year.

7. The system of claim 1, further comprising:
aggregating one or more subsets of records from the first records into one or more aggregate records, the subsets of records each corresponding to a single date from the one or more dates.

8. The system of claim 7, wherein the deriving second marketing campaign data for a designated date range comprises aggregating one or more subsets of the aggregate records, the subsets of the aggregate records each corresponding to a date included in the designated date range.

9. The system of claim 1, further comprising:
generating one or more additional records, the additional records each including a date outside of the designated date range; and
aggregating the one or more additional records based on a second designated date range.

10. The system of claim 9, further comprising:
populating a record for the second designated date range, the record including the aggregation of the one or more additional records.

11. A method comprising:
identifying a first plurality of records maintained using a non-relational database in a database system, the first records comprising at least first marketing campaign data for one or more dates;
generating a second plurality of records based on the first records, the generating of each of the second plurality of records comprising:
deriving second marketing campaign data for a designated date range from at least a portion of the first marketing campaign data and from at least a portion of the one or more dates, and
populating a record with the second marketing campaign data for the designated date range;
storing the second records in a relational database;
receiving a query of the relational database, the query including at least one or more records from the second records; and
generating a query result in response to the query in real time or substantially real time.

12. The method of claim 11, further comprising:
generating a graphic based on the second records in the relational database to have graphical content corresponding to the second marketing campaign data and one or more designated date ranges of the second records, the graphic being displayable on a display of a device.

13. The method of claim 12, wherein the graphic comprises at least a portion of a time series report.

14. The method of claim 11, wherein the deriving second marketing campaign data for a designated date range comprises aggregating one or more subsets of records from the first records, the subsets of records each corresponding to a date included in the designated date range.

15. The method of claim 11, wherein the designated date range is one of: a day, a week, a month, a quarter, or a year.

16. The method of claim 11, further comprising:
generating one or more additional records, the additional records each including a date outside of the designated date range; and
aggregating the one or more additional records based on a second designated date range.

17. The method of claim 16, further comprising:
populating a record for the second designated date range, the record including the aggregation of the one or more additional records.

18. A computer program product comprising computer-readable program code capable of being executed by one or more processors when retrieved from a non-transitory computer-readable medium, the program code comprising instructions configurable to cause:
identifying a first plurality of records maintained using a non-relational database, the first records comprising at least first marketing campaign data for one or more dates;
generating a second plurality of records based on the first records, the generating of each of the second plurality of records comprising:
deriving second marketing campaign data for a designated date range from at least a portion of the first marketing campaign data and from at least a portion of the one or more dates, and
populating a record with the second marketing campaign data for the designated date range;
storing the second records in a relational database; and
generating a graphic based on the second records in the relational database to have graphical content corresponding to the second marketing campaign data and one or more designated date ranges of the second records, the graphic being displayable on a display of a device.

19. The computer program product of claim 18, the instructions further configurable to cause:
generating a graphic based on the second records in the relational database to have graphical content corresponding to the second marketing campaign data and one or more designated date ranges of the second records, the graphic being displayable on a display of a device.

20. The computer program product of claim 18, wherein the deriving second marketing campaign data for a designated date range comprises aggregating one or more subsets of records from the first records, the subsets of records each corresponding to a date included in the designated date range.
